(19) United States
(12) Patent Application Publication
(10) Pub. No.: US 2016/0241699 A1
(43) Pub. Date: Aug. 18, 2016

(54) DEVICE, SYSTEM AND METHOD FOR PROVIDING EXCLUSIVE WIRELESS DATA TRANSFER SERVICE BETWEEN MOBILE APPLICATIONS AND REMOTE SERVERS THROUGH AN IN-VEHICLE TELEMATICS DEVICE

(71) Applicant: BLUE DOT SOLUTIONS, LLC, Denver, CO (US)

(72) Inventors: Mick Milnark, Denver, CO (US); Randy M. Starr, Denver, CO (US); Daniel McShan, Littleton, CO (US)

(21) Appl. No.: 14/624,233

(22) Filed: Feb. 17, 2015

(51) Int. Cl. H04M 1/725; H04L 29/08

(52) U.S. Cl. CPC H04M 1/72527; H04L 67/12

(57) ABSTRACT

A device, system and method for providing an exclusive wireless data transfer service between one or more authorized mobile applications (apps) and one or more remote servers through an in-vehicle telematics device is shown and described. The invention includes establishing a wireless network connection between the WWAN communications electronics of the vehicle telematics device and one or more remote servers and a wireless network connection between the WPAN communications electronics of the vehicle telematics device and a mobile device hosting one or more authorized apps. The invention further includes using specialized application programming interfaces (APIs) that exclusively grant certain authorized apps the ability to use the two wireless network connections to transfer data back and forth between the remote server and apps on the mobile device while prohibiting all other apps and services from doing the same. The resulting communications system enables the authorized apps on a mobile device to interact with remote servers in situations where the mobile device does not have WWAN capability or without using the WWAN data plan of the mobile device. The invention will exclude all other apps and services on the mobile device from using the WPAN and WWAN connections of the vehicle telematics device.

### FIELD OF THE INVENTION

The present invention relates generally to a device, system and method for providing wireless data transfer service for mobile devices by using the Wireless Wide Area Network (“WWAN”) and Wireless Personal Area Network (“WPAN”) communications capabilities of in-vehicle telematics systems.

### BACKGROUND OF THE INVENTION

Many employers wish to allow their mobile workers (e.g. employees and/or contractors) to use their personal mobile devices (e.g. smart phones, personal digital assistants, laptops, tablets, etc.) to run specific, authorized applications (“apps”) such as business-specific apps, but elect not to do so for a variety of reasons, including security concerns and obligations to subsidize or reimburse workers for expenses related to the business use of the data plan for the personal mobile device.

Alternatively, employers may wish to provide less expensive mobile devices that do not have built-in WWAN capabilities to their mobile workers but cannot because the desired business-specific apps require occasional or regular network access to data and/or services hosted on remote servers in order to be effective.

In many cases, these mobile workers use employer provided vehicles in the performance of their daily tasks. These vehicles may even contain in-vehicle telematics devices to capture and wirelessly transmit a variety of asset, location, and movement data to centralized computer software systems (e.g. Fleet Management System).

Conventional in-vehicle telematics systems having such wireless data transmission capabilities are unable to provide data transfer services to other devices such as personal mobile devices, particularly in a fashion that supports certain authorized apps, such as business-specific apps, but not personal apps.

### SUMMARY OF INVENTION

The following summary is provided to facilitate an understanding of some of the innovative features unique to the present invention. The present invention is not intended to be limited by this summary.

The present invention relates generally to a device, system and method for providing wireless data transfer service for mobile devices by using the WWAN and WPAN communications capabilities of in-vehicle telematics systems. This invention will allow data transfer services in situations where the mobile device does not have WWAN capability and in situations where there is a desire not to use the WWAN capability of a mobile device, i.e., the mobile device is a non-secure personal device. This invention will enable businesses to allow its mobile workers to use a variety of mobile devices to run certain authorized, i.e. business-specific, applications to make the mobile workers and the business more efficient and effective.

In an embodiment of the present invention, an in-vehicle telematics device is plugged into a diagnostic port of a vehicle, such as an OBD-II port or a J1939 port. Most personal vehicles have OBD-II ports located near the engine or the dashboard. Commercial vehicles will generally have a J1939 diagnostic port. In an embodiment of the present invention, one component of the telematics device is the communications electronics to support a WWAN connection over one or more of the standard cellular data protocols that are available. Another component is the communications electronics to support a WPAN connection over standard wireless data protocols such as Bluetooth or Wi-Fi. Through these components, the in-vehicle telematics device is able to establish a WWAN connection to a remote server and a WPAN connection to a mobile device. In this embodiment of the present invention, an additional component or feature of the in-vehicle telematics device is software that supports a secure and authenticated WPAN connection between mobile devices running specified software applications that are designed and authorized to utilize such a connection and designed to refuse or disallow a connection from any other mobile devices and/or software. In this embodiment, an additional feature of the in-vehicle telematics device is a software application-programming interface (“API”) that provides low-level access to many of its components. In this embodiment, an authorized app on a mobile device, such as a business-specific app that is designed to use the API, has the ability to send commands to the in-vehicle telematics device via the WPAN connection and request a network connection from the WWAN component. In this example, once a WWAN connection has been provided to the authorized app, it can send and receive data to/from a remote server without a mobile device having or using its own WWAN capability.

In another embodiment of the present invention, the in-vehicle telematics device includes components that support the electronics and associated software required to capture and log a variety of telematics data such as GPS information (e.g., location, speed, and heading); accelerometer & gyroscope data (e.g., acceleration, deceleration, yaw, cornering force); and vehicle data (e.g., vehicle identification, fuel level, fuel efficiency, active engine diagnostic codes, etc.). This data is captured, logged, and transmitted via the WWAN connection established through the in-vehicle telematics device to a centralized computer system for subsequent review and analysis.

In a further embodiment, the present invention includes an app loaded on a mobile device wherein the app is designed and authorized to use the API for the in-vehicle telematics device and has the ability to make requests from specific components of the in-vehicle telematics device via the WPAN connection. Such requests may include real-time GPS information (e.g., location, speed, and heading) and real-time vehicle information (e.g., vehicle identifier, fuel level, active engine diagnostic codes, etc.).

In yet another embodiment, the present invention includes an app on a mobile device wherein the app is authorized and designed to use the API for the in-vehicle telematics device and has the ability to access previously logged vehicle telematics data via the WPAN connection. In a preferred embodiment, the app is authorized to use the WPAN provided through the in-vehicle telematics device by making the connection through the API by providing a required security token.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF DRAWINGS

The accompanying figures are incorporated herein and form a part of the specification for the present invention and further illustrate the present invention:

FIG. 1 is a diagram of an embodiment of an in-vehicle telematics device used in the present invention, showing different components of the device.

FIG. 2 is a high-level diagram of a system using an in-vehicle telematics device to provide a WPAN network connection to a mobile device and a WWAN network connection to a remote server.

FIG. 3 is a block diagram providing details of a system using an in-vehicle telematics device to provide a WPAN network connection to a mobile device and a WWAN network connection to a remote server.

FIG. 4 is a flow diagram of a method for using an in-vehicle telematics device to provide a WPAN network connection to a mobile device to transmit and/or receive data to/from a remote server through the in-vehicle telematics device.

### DETAILED DESCRIPTION OF INVENTION

The present invention is best understood by reference to the detailed drawings and description set forth herein. Embodiments of the invention are discussed below with reference to the drawings. However, those skilled in the art will readily appreciate that the detailed description given herein with respect to the drawings is for explanatory purposes as the invention extends beyond the limited embodiments described. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means. Also, singular words should be read as plural and vice versa and masculine as feminine and vice versa, where appropriate, and alternative embodiments do not necessarily imply that the two are mutually exclusive.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that, if a specific number for a claim recitation is intended, such an intent will be explicitly recited in the claim, and in the absence of such recitation, no such intent is present. For example, as an aid to understanding, the appended claims may contain usage of the introductory phrases “at least one” and “one or more” to introduce claim recitations. However, the use of such phrases should not be construed to imply a claim recitation by the indefinite articles “a” or “an” limits any particular claim containing such claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of claim recitations is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

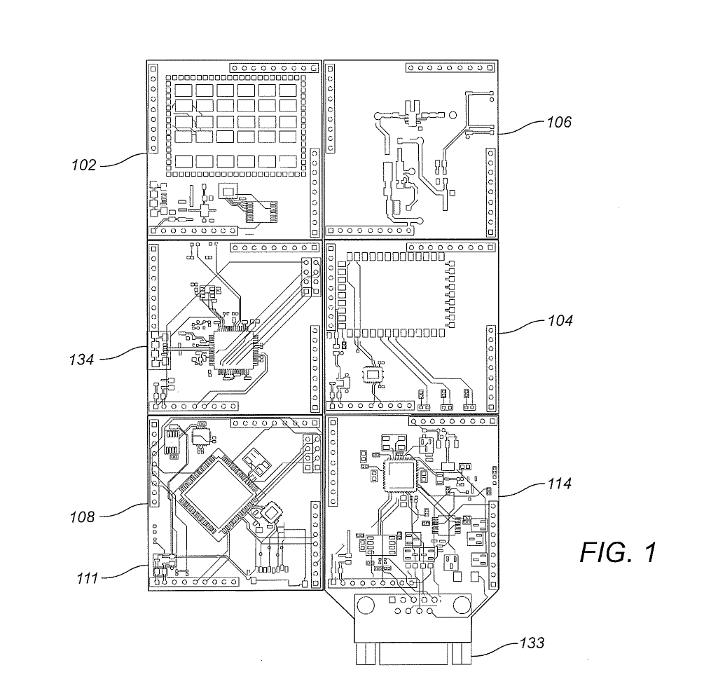

To illustrate embodiments of the present invention, reference is made to the drawings. FIG. 1 is an embodiment of an in-vehicle telematics device 100 of the present invention. In this embodiment, the device 100 includes components consisting of electronics and software 114 for interfacing with a vehicle's engine diagnostic port via an OBD-II or J1939 interface and a connector 133 for connecting the device 100 to a diagnostic port in a vehicle using OBD-II or J1939. In a preferred embodiment, the connector 133 for connecting the in-vehicle telematics device 100 includes a DB-9 port and adapter cables for connecting to the either an OBD-II port or J1939 port. The use of a cable adapter will enable the in-vehicle telematics device 100 to connect to the diagnostic port and also be located at a favorable position within the vehicle that is not dictated by the location of the vehicle's engine diagnostic port.

The embodiment of an in-vehicle telematics device 100 shown in FIG. 1 also includes WWAN communications electronics and software 102 to support connectivity to one or more remote software systems via a cellular tower and data network. In a preferred embodiment, the WWAN communications electronics and software 102 will support cellular data technologies currently in use and allow for upgrades as cellular data technologies continue to advance. In particular, the electronics and software 102 are modular for ease of replacement and upgrade. The in-vehicle telematics device 100 of this embodiment also includes WPAN communications electronics and software 104 that provide connectivity to a variety of smartphones, tablets, laptops, and other similar mobile devices. In a preferred embodiment, the WPAN communications electronics and software 104 will support current Wi-Fi wireless data technologies and will allow for upgrades and updates as wireless data technologies continue to advance. In particular, the electronics and software 104 are modular for ease of replacement and upgrade.

The in-vehicle telematics device 100 may further include a microprocessor 108 and memory card 111 as well as a battery 106 for providing backup power to the components. The in-vehicle telematics device 100 may also include a USB port 134 for internal testing and diagnostics purposes. Other components such as a GPS receiver, an accelerometer, a compass, and a gyroscope also may be included in the in-vehicle telematics device 100.

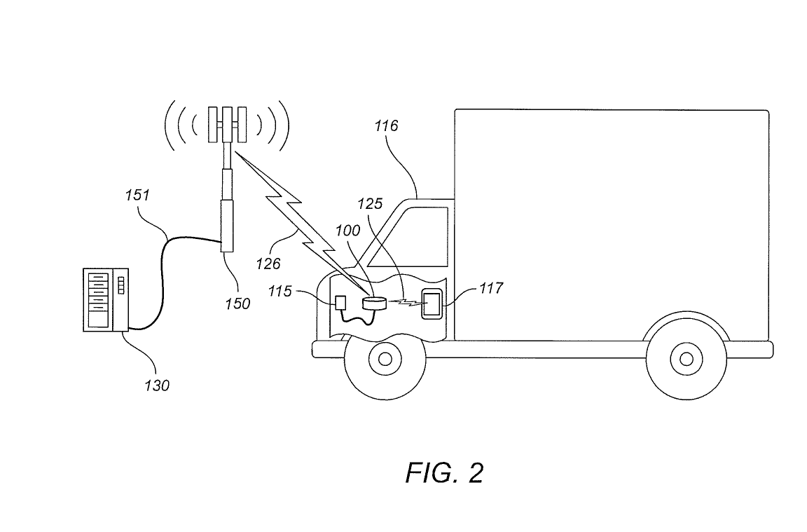

FIG. 2 shows an embodiment of the communications system of the present invention, including an in-vehicle telematics device 100 for a vehicle 116. The in-vehicle telematics device 100 includes components described in FIG. 1, including electronics, software and an adapter for connecting the device 100 to a vehicle's engine diagnostic port 115 via an OBD-II or J1939 interface to capture and log a variety of vehicle data. The in-vehicle telematics device 100 of this embodiment also includes electronics and software that provide WWAN 126 to support connectivity to one or more remote software systems 130 via a cellular tower 150 and data network 151. The in-vehicle telematics device also includes electronics and software that provide a WPAN 125 to support connectivity to a variety of smartphones, tablets, laptops, and other similar mobile devices 117. The in-vehicle telematics device 100 of the present invention also includes an API that limits access to authorized apps.

Through these components, the in-vehicle telematics device 100 can act as a communications hub for authorized software on a mobile device that is specifically designed to use the API for the in-vehicle telematics device 100 while excluding similar use by other software on the mobile device, thereby enabling certain specifically authorized software to communicate with remote software systems 130 without requiring its host mobile device to have or use its own WWAN capabilities.

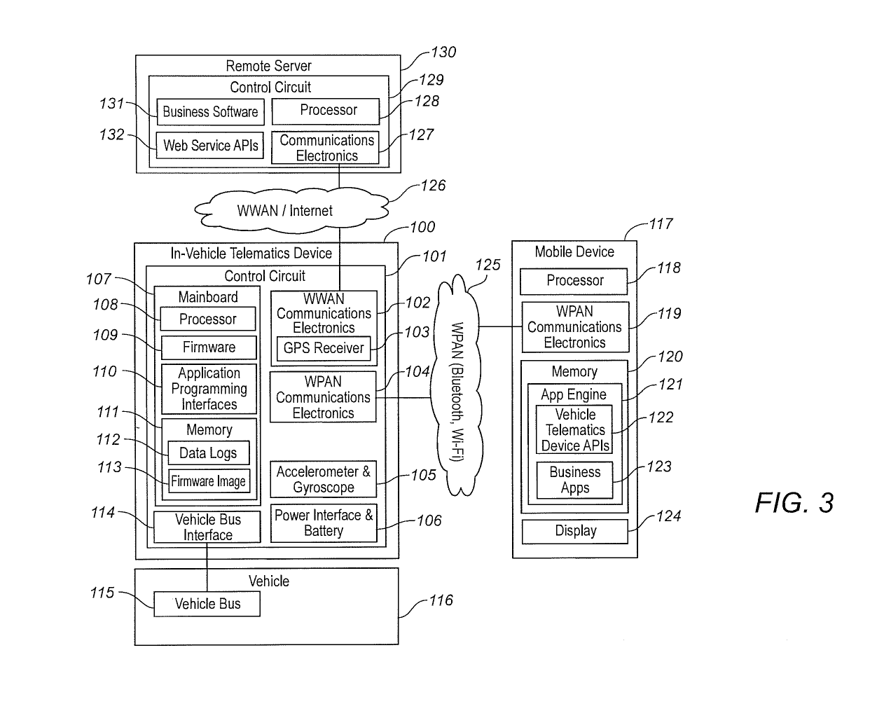

FIG. 3 is a block diagram illustrating an embodiment of the communication system of the present invention comprising an in-vehicle telematics device 100 with the following components:
a control circuit 101;
a WWAN communications electronics 102, namely a transceiver, for transmitting and receiving WWAN communications signals via standard cellular data protocols;
a GPS receiver 103 for receiving and processing global positioning signals to assist in determining the current location, heading, and speed of the vehicle 116;
wireless personal area network (“WPAN”) communications electronics 104, namely a transceiver, for transmitting and receiving WPAN communications signals via standard WPAN protocols;
an accelerometer and gyroscope 105, including hardware and electronics, for measuring the acceleration, deceleration, and cornering forces of a vehicle 116;
a power interface 106 that allows the power requirements for the device 100 to be met through the electronics system of a vehicle 116 using the vehicles bus 115 and a battery 106 for meeting the backup power requirements for the components of the in-vehicle power device 100;
a mainboard 107 and microprocessor 108 to support the software operating system 109 of the in-vehicle telematics device 100;
other software 109 to provide the operating environment and programming of the in-vehicle telematics device 100;
hardware and electronics 114 for interfacing with vehicle 116 diagnostic port or bus 115 to provide power to the device 100 as well as capturing vehicle telematics data, such as current or recent Diagnostic Trouble Codes, engine RPMs, vehicle runtime, etc.;
a memory card 111, including hardware and electronics, to capture logged data 112 from the various components of the in-vehicle telematics device including the GPS receiver 103, the accelerometer and gyroscope 105, and the vehicle diagnostic port 114 as well as to persist the newest firmware image 113 of the in-vehicle telematics device;
software APIs 110 to provide programmatic access to various components of the in-vehicle telematics system including the WWAN transceiver 102, the GPS receiver 103, the WPAN transceiver 104, the accelerometer and gyroscope 105, the battery or power interface 106, the mainboard 107, the memory card 111, or the in-vehicle diagnostic port 114, as well as to establish and secure authenticated WWAN and WPAN network connections.

The embodiment of the communications system of FIG. 3 also includes a mobile device 117, such as a smart phone, tablet, lap top or similar device, comprising:
hardware and electronics such as a processor 118, a memory card 120, and a display 124 to support the software operating system and user experience of the mobile device 117;
WPAN communications electronics 119, namely a transceiver, for transmitting and receiving WPAN communications signals via standard wireless personal area data protocols 125;
software 121 to provide the operating environment and programming of an app engine; and
software APIs 122 to provide programmatic access to and interaction with the in-vehicle telematics device 100 to apps 123 running on the mobile device 117.

The embodiment of the communications system of FIG. 3 also includes a remote server 130 comprising:
a processor 128 and control circuit 129 to support the software operating system and user experience of the remote server 130;
communications electronics 127, including hardware and electronics, for WWAN communications with other software and hardware through standard http over TCP-IP data protocols 126; and
software APIs 132 to provide programmatic access to and interaction with software applications 131 running on the remote server 130.

The embodiment of the communications system of FIG. 3 also includes a vehicle 116 and an in-vehicle diagnostic port 115 such as an OBD-II or J1939 port.

The communications system of FIG. 3 allows a user to wirelessly transfer data and information from a mobile device 117 using the in-vehicle telematics system 115 through certain authorized apps 123.

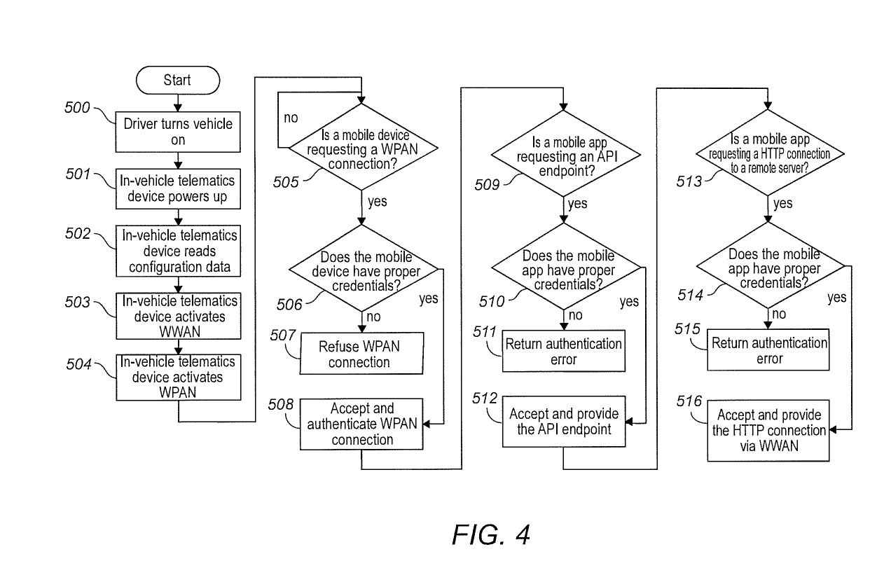

In reference to the communications system of FIG. 3, FIG. 4 provides a flow diagram for an embodiment of a process of the present invention for establishing a data communications link between an authorized mobile app 123 on a mobile device 117 and a remote server 130 through the in-vehicle telematics device 100 attached to a vehicle 116 diagnostic port 115. A driver turns on a vehicle 116 containing the in-vehicle telematics device 100 on (step 500). The in-vehicle telematics device 100 receives power from the vehicle bus interface 115 and powers up (step 501). The in-vehicle telematics device 100 reads a configuration file and uses the data within to specify how a number of its internal components and subsystems are going to work; e.g., the SSID, encryption protocol, and passphrase or authentication token for the WPAN transceiver 104 (step 502). The in-vehicle telematics device activates the WWAN transceiver (step 503) and the WPAN transceiver (step 504) and applies the appropriate values from the configuration file. Whenever a mobile device 117 requests a WPAN connection with the in-vehicle telematics device 100 (step 505), the mobile device's WPAN networking credentials are authenticated against those set for the WPAN transceiver (step 506). If the credentials do not match, the WPAN network connection request is refused (step 507). If the credentials match, the WPAN network connection request is accepted and a WPAN network connection is established between the in-vehicle telematics device 100 and the mobile device 117 (step 508). Whenever a WPAN connected mobile app requests an API 110 endpoint (step 509), the in-vehicle telematics device 100 checks to see that the provided API access credentials match those in the configuration file (step 510). If the credentials do not match, an authentication error is returned (step 511). If the credentials do match, the requested API 110 endpoint is returned (step 512). If a WPAN connected mobile app 123 requests a HTTP connection to a remote server 130, the in-vehicle telematics device 100 checks to see if the provided HTTP authentication credentials are accepted by the remote server (step 514). If the credentials are not accepted, a HTTP authentication error is returned (step 515). If the credentials are accepted, a HTTP connection via the WWAN 102 of the in-vehicle telematics device 100 is returned to the mobile app 123 (step 516). The mobile app 123 is then able to transfer data back and forth to the remote server 130 until the connection is closed.

It is to be understood that the foregoing description is intended to illustrate and not limit the scope of the invention, which is defined by the scope of the appended claims. Other aspects, advantages, and modifications are within the scope of the following claims.

What is claimed is:

1. A communications system comprising:
a vehicle with a diagnostic port;
an in-vehicle telematics device connected to the diagnostic port of said vehicle whereby said in-vehicle telematics device includes communications electronics for establishing WWAN communications using standard WWAN protocols, communications electronics for establishing WPAN communications with a mobile device using standard WPAN protocols, a microprocessor, operating software for the in-vehicle telematics device, an API for restricting access to the in-vehicle telematics device, and a power source for the in-vehicle telematics device; and
a mobile device including WPAN communications electronics, an app, and an API for restricting communication between the app and the in-vehicle telematics device.

2. The communications system of claim 1, wherein the specialized API included in the in-vehicle mobile device provides secure programmatic access to said mobile device.

3. A method for communicating using an in-vehicle telematics device connected to a vehicle diagnostic port, comprising the steps of:
establishing a secure communications link between the WPAN communications electronics of the in-vehicle telematics device and the WPAN communications electronics of a mobile device;
using an API for the WPAN secure communications link between the in-vehicle telematics device and the mobile device to support requests from an app running on the mobile device;
establishing a secure communications links between the WWAN communications electronics of the in-vehicle telematics device and a remote server;
using the secure WWAN communications link and the secure WPAN communications link to support data transfers between the app running on the mobile device and the remote server.

4. A communications system allowing restricted transfer of data between a mobile device and a remote server using a vehicle's diagnostic port, comprising:
an in-vehicle telematics device connected to the vehicle diagnostic port whereby the in-vehicle telematics device includes communications electronics for establishing WWAN communications with a remote server using standard WWAN protocols, communications electronics for establishing WPAN communications with the mobile device using standard WPAN protocols, a microprocessor, operating software for the in-vehicle telematics device, and a power source for the in-vehicle telematics device;
an app and an API running on said mobile device to limit and provide secure WPAN communications between the in-vehicle telematics device and the mobile device;
an API running on the in-vehicle telematics device to limit and provide secure WWAN communications between the in-vehicle telematics device and the remote server.

5. An in-vehicle telematics device for use in providing secure communications between a mobile device and a remote server, whereby the in-vehicle telematics device comprises:
electronics and software for connecting the in-vehicle telematics device to a diagnostic port of a vehicle;
communications electronics for establishing WWAN communications using standard WWAN protocols;
communications electronics for establishing WPAN communications with a mobile device using standard WPAN protocols;
a microprocessor;
operating software;
an API for restricting access to and communications with the in-vehicle telematics device; and
a means for powering the in-vehicle telematics device.

6. An in-vehicle telematics device of claim 5 wherein said device further includes a GPS receiver.

7. An in-vehicle telematics device of claim 5 wherein said device further includes an accelerometer, compass, and gyroscope.

8. An in-vehicle telematics device of claim 5 wherein said device further includes a memory card.
